(19) United States
(12) Patent Application Publication
(10) Pub. No.: US 2025/0054422 A1
(43) Pub. Date: Feb. 13, 2025

(54) Handheld Warning Sign

(71) Applicant: Theory Stringer, Deltona, FL (US)

(72) Inventor: Theory Stringer, Deltona, FL (US)

(21) Appl. No.: 18/448,509

(22) Filed: Aug. 11, 2023

(51) Int. Cl. G09F 27/00; G09F 19/12

(52) U.S. Cl. CPC G09F 27/004; G09F 19/12; G09F 27/007

(57) ABSTRACT

A handheld warning sign including front and back with at least one side having a predetermined color and warning information printed on the sign. A handle member is fastened to the bottom of the sign enabling it to be handheld. A longer pole extension structure can be attached to sign handle member enabling it to extend to the ground allowing the sign to be a pole sign. An electronic sound device is positioned within the handle of the sign and connected to a battery and a off and on power switch. Wireless LED lights are attached to the sign and when the electronic sound device button is pushed it activates both the electronic sound and the lights. The electronic sound device produces electronic warning sounds and the warning lights flash to attract the attention of motorists or pedestrians to safely follow the directions of the safety personnel.

### FIELD OF THE INVENTION

The invention relates to handheld regulatory information signs for motorist traffic control on and off public roads, and pedestrian street crossing safety.

### BACKGROUND OF THE INVENTION

Prior to the conception and development of the present invention, safety personnel such as traffic police, school crossing guards, and construction workers, have used handheld signs to direct pedestrian traffic and to help children safely cross streets and intersections. Sometimes motorist are distracted on roadways near intersections, school zones, construction sites, and places where children and pedestrians cross roadways endangering the lives of other motorist and especially pedestrians.

Traffic officers, flagmen, and school crossing guards, often use whistles along with handheld signs to aid in controlling traffic and helping children and other pedestrians safely cross at dangerous intersections and roads around schools by blowing whistle warning sounds to alert motorist to “STOP,’ when pedestrians are about to cross the road. However because of a concern that blowing air through a whistle around others increases the chances of spreading germs and other infectious bacteria into the air, many agencies require masks to be worn by safety personnel. Mask are required at some schools. So it is not practical to use traditional whistles around pedestrians because of this requirement.

There have been some improvements made on handheld signs by adding battery powered lights to the signs to better alert and warn drivers and pedestrians at intersections, in road constructions areas, and school crossings for safer traffic control. Also because of the mask requirements, some state and county agencies have implemented the use of handheld electronic whistles instead of traditional whistles for safety personnel.

A short coming of using a handheld electronic whistle is that the safety personnel's directing band is no longer always free when performing their duties. Although the battery powered light sign is a good improvement over the standard handheld sign for warning motorist and pedestrians, the visual effects of this sign is not as effective as the piercing sound of a whistle or other electronic sounds in arresting motorist and pedestrians attention.

It is therefore an object of the invention to provide a handheld sign that can emit electronic generated sounds such as a whistle, horn, siren, or other electronic sounds to warn and assist pedestrians in safely crossing roads and intersections.

It is another object of the invention to provide a handheld sign that can emit electronic generated sounds for the use of traffic control.

It is another object of the invention to provide a handheld sign that can emit electronic generated sounds without the operator spreading germs into the air by blowing a whistle.

It is another object of the invention is to provide a handheld sign that can emit electronic generated warning sounds in conjunction with wireless battery and or solar powered LED warning lights to aid in safely controlling vehicle and pedestrian traffic.

It is another object of the invention to provide a handheld sign that can emit electronic generated sounds that can be held in one hand by the operator enabling their other hand to always be free to direct traffic and pedestrians.

It is another object of the invention to provide a handheld sign to better assist safety personnel in traffic control.

### SUMMARY OF THE INVENTION

In accordance with the present invention, there is provided a light-weight handheld sign that displays regulatory information on one or both sides of the sign expanse. A handle member securely connected to the bottom of the sign enabling it to be held with one hand. A pole extension structure can be attached to the sign's handle member enabling the base to stand on the ground and held by the hand as a pole sign. An electronic sound device powered by at least one rechargeable, or disposable battery and positioned inside the sign's handle member or pole structure. Wireless battery and or solar powered LED warning lights are secured to the sign and having an electronic control board secured inside the handle member and connected to the electronic sound device and controlled with the same switch and button for the electronic sound device enabling the warning sounds and lights to work together or independently. An “on and off” power switch on the handle member controls the power flow from the battery to the electronic sound device and wireless LED warning light control board. When the power switch is on, and the warning sound device button is pressed, the electronic sound device emits a warning sound and the wireless LED warning lights come on to warn motorists or pedestrians.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front view of a stop/slow handheld sign device with warning system displaying the stop side of the sign according to a presently preferred embodiment of the present invention;

FIG. 2 is a rear view of a stop/slow handheld sign according to a presently preferred embodiment of the present invention;

FIG. 3 is a front view of a sign with pole extension according to a presently preferred embodiment of the present invention;

FIG. 4 is a rear view of a sign with pole extension;

FIG. 5 is a right view of a handheld sign handle member.

FIG. 6 is a front exploded view of a handheld sign handle member with electronic sound device; and the sound vent at the bottom of handle member.

FIG. 7 is a bottom perspective view of a handheld sign handle member showing the sound vent.

FIG. 8 is a front view of a stop/slow handheld sign device with warning system displaying the stop side of the sign with wireless battery powered LED warning lights according to a presently preferred embodiment of the present invention;

FIG. 9 is a front view of a stop/slow handheld sign device with warning system displaying the slow side of the sign with wireless battery powered LED warning lights according to a presently preferred embodiment of the present invention;

FIG. 10 is a front exploded view of the handheld sign 1 handle member showing an electronic sound device, a wireless battery powered LED warning light control board and connected to power switch, electronic sound device button, and battery.

### DESCRIPTION OF THE PREFERRED EMBODIMENT

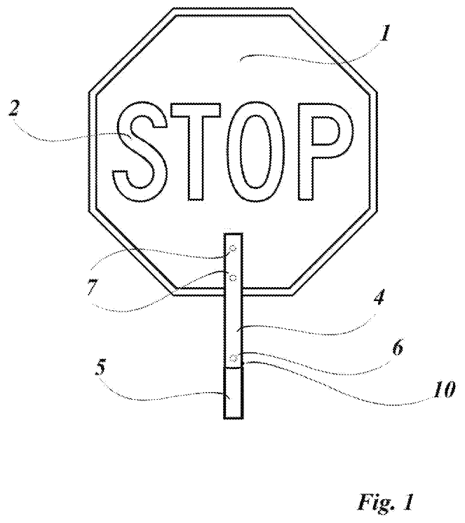

FIG. 1 is a front view of a handheld sign 1 showing the regulatory information stop 2 on the front expanse of Sign 1. Sign 1 is connected to the handle member 4 with fasteners 7. A handle grip 5 is secured to the handle member 4 to comfortably hold sign 1 with hand. An electronic sound device 9 having at least one battery 12 is located inside handle member 4. Power switch 10 is connected to the electronic sound device 9 and when power switch 10 is in the ON position it sends power from the battery 12 to the electronic sound device 9. Sound device button 6 is mounted on the handle member 4. When the sound device Button 6 is pressed, it emits a warning sound including a whistle or other electronic sounds.

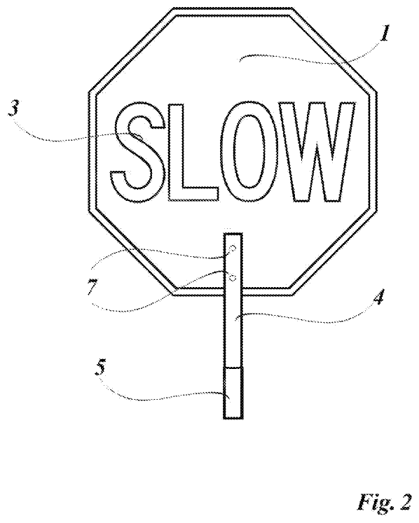

FIG. 2 is a rear view of a handheld sign 1 showing the Regulatory information Slow 3 on the rear expanse of Sign 1. Sign 1 is connected to the handle member 4 with fasteners 7. A handle grip 5 is secured to the handle member 4 to comfortably hold sign 1 with hand. An electronic sound device 9 having at least one battery 12 is located inside handle member 4. A sound device button 6 is mounted on the handle member 4 to activate the battery 12 powered electronic sound device 9. When power switch 10 is in the ON position and sound device button 6 is pressed, the electronic sound device 9 emits a warning sound including a whistle or other electronic sounds.

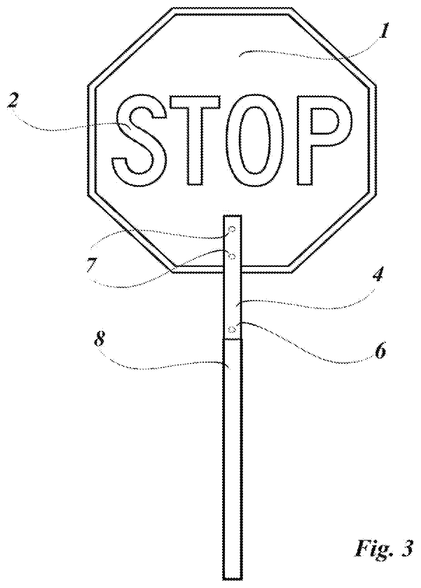

FIG. 3 is a front view of a sign 1 having the regulatory stop 2 on the front expanse of the sign 1. Sign 1 having the regulatory instruction stop 2 o the front expanse of the sign. Sign 1 is connected to the handle member 4 with fasteners 7. A Pole Extension 8 is connected to the handle member 4 with fasteners 7 allowing sign 1 to stand on the ground and held with one hand. A battery 12 powered electronic sound device 9 is located inside handle member 4. A sound device button 6 is located on the handle member 4 and is connected to the battery 12 powered electronic sound device 9. When power switch 10 is in the ON position and sound device button 6 is pressed, the electronic sound device 9 emits a warning sound including a whistle or other electronic sounds.

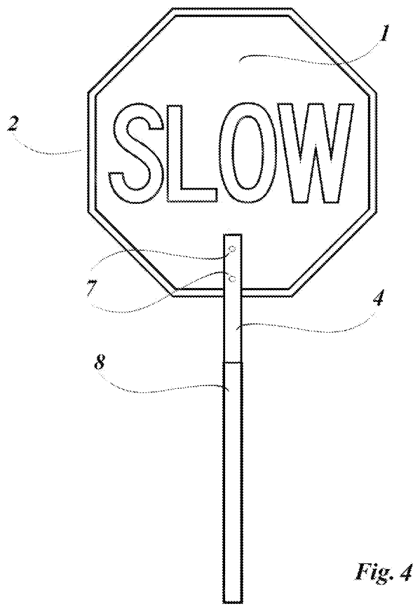

FIG. 4 is a rear view of a sign 1 having the regulatory instruction-Slow 3 on the rear expanse of the sign 1. Handle member 4 is fastened to the sign 1 with fasteners 7. A Pole Extension 8 is connected to the handle member 4 extending the handle allowing the sign 1 assembly to stand on the ground and held with one hand. An electronic sound device 9 connected to a rechargeable battery 12 or other power source inside the handle member 4 is activated by pressing the sound device button 6 located on handle member 4 of sign 1.

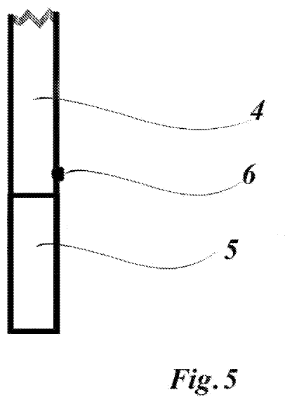

FIG. 5 is a right side view of the handheld sign 1 handle member 4 with handle grip 5 showing the sound device button 6 located on handle member 4.

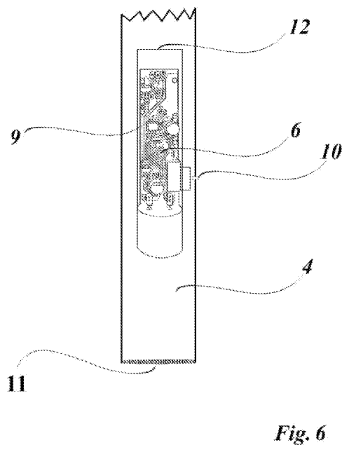

FIG. 6 is a front exploded view of the handheld sign 1 handle member 4 showing a battery 12, electronic sound device 9 connected to sound device button 6 on handle member 4. The power switch 10 is connected to the electronic sound device 9 and when the power switch 10 is in the ON position it sends power from the battery 12 to the electronic sound device 9. And when sound device button 6 is pressed the electronic sound device 9 emits a warning sound including a whistle, siren, or other warning sounds that comes out of the bottom end of handle member 4 through the sound vent 11.

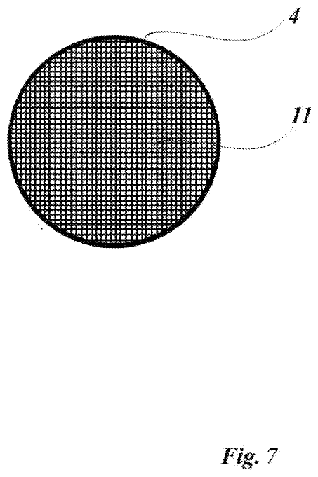

FIG. 7 is a bottom perspective of the handheld Sign 1 showing the sound vent 11 at the bottom of the handle member 4 that allows electronic warning sounds including a whistle, siren, or other electronics sounds to pass down through the handle member 4 and out through the sound vent 11 when power switch 10 is in the ON position and the sound device button 6 is pressed.

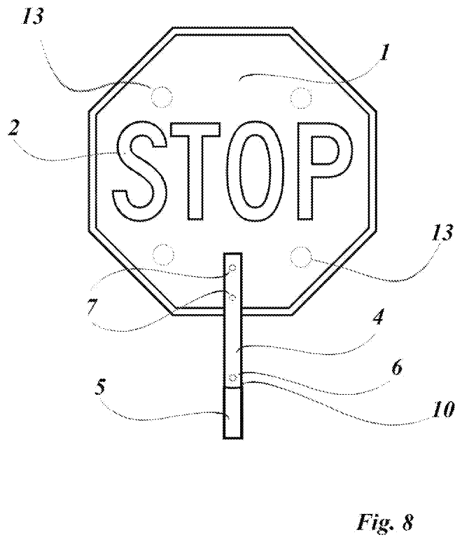

FIG. 8 is a front view of a handheld sign 1 showing the regulatory information stop 2 with wireless battery powered LED warning lights 13 on the front expanse of Sign 1. Sign 1 is connected to the handle member 4 with fasteners 7. A handle grip 5 is secured to the handle member 4 to comfortably hold sign 1 with hand. An electronic sound device 9 having at least one battery 12 is located inside handle member 4. The power switch 10 is connected to the battery 12, the electronic sound device 9 and the wireless battery powered LED warning lights control board 14. When power switch 10 is in the ON position, it sends power from the battery 12 to the electronic sound device 9 and to the wireless battery powered LED warning lights control board 14 fastened inside the handle member 4 and connected to the electronic sound device 9. The sound device button 6 is mounted on the handle member 4. When the sound device button 6 is pressed, the electronic sound device 9 emits a warning sound including a whistle or other electronic sounds, and at the same time remotely sends a signal to the wireless battery powered LED warning lights 13 for them to come on and to remain on, or to start flashing.

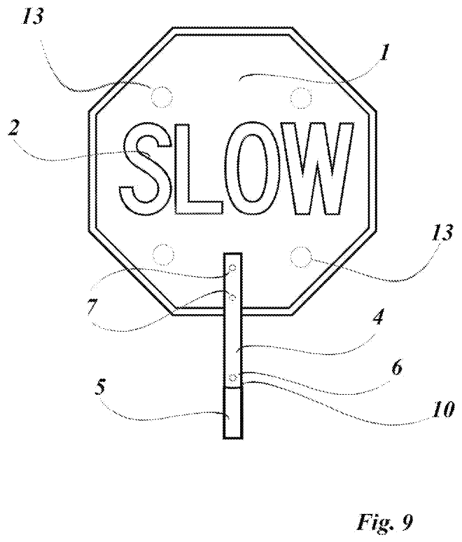

FIG. 9 is a front view of a handheld sign 1 showing the regulatory information slow 3 with wireless battery powered LED warning lights 13 on the front expanse of Sign 1. Sign 1 is connected to the handle member 4 with fasteners 7. A handle grip 5 is secured to the handle member 4 to comfortably hold sign 1 with hand. An electronic sound device 9 having at least one battery 12 is located inside handle member 4. The power switch 10 is connected to the battery 12, to the electronic sound device 9 and the wireless battery powered LED warning lights control board 14. When power switch 10 is in the ON position it sends power from the battery 12 to the electronic sound device 9 and the wireless battery powered LED warning lights control board. The sound device button 6 is mounted on the handle member 4. When the electronic sound device button 6 is pressed, the electronic sound device 9 emits a warning sound including a whistle or other electronic sounds, and at the same time remotely sends a signal to the wireless battery powered LED warning lights 13 for them to come on and to remain on, or to start flashing.

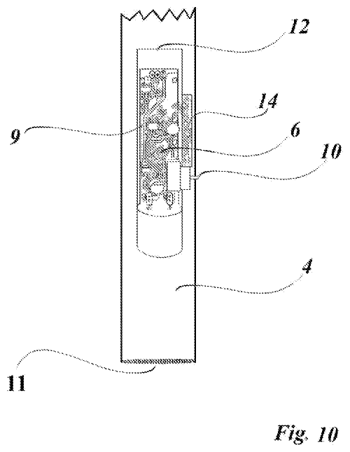

FIG. 10 is a front exploded view of the handheld sign 1 handle member 4, showing an electronic sound device 9 connected to power switch 10 with the power switch 10 connected to electronic sound device button 6 and battery 12. The wireless battery powered LED warning lights control board 14, is also connected to power switch 10 that is connected to electronic sound device button 6 and battery 12. When the power switch 10 is in the ON position, it sends power from the battery 12 to the electronic sound device 9, and to the wireless battery powered LED warning lights control board 14 and when the electronic sound device button 6 is pressed, the electronic sound device 9 emits a warning sound warning sounds that comes out of the bottom end of handle member 4 through the sound vent 11 including a whistle or other electronic sounds, and at the same time remotely sends a signal to the wireless battery powered LED warning lights 13 for them to come on, and to remain on, or to start flashing.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention. Having thus described the invention, what is desired to be protected by Letters Patent is presented in the subsequently appended claims.

What is claimed:

1. A handheld sign device with warning system, comprising;
means for aiding safety personnel in controlling motorist traffic in construction areas, intersections, schools zones and other areas where pedestrians cross roadways;
a means for providing regulatory information to vehicle traffic and pedestrians to stop or to go when instructed;
a means for attracting the attention of automobile drivers and pedestrians and aiding in directing road and pedestrian traffic by emitting an electronic warning sound including a whistle, siren, and other warning sounds simultaneously along with flashing wireless battery powered LED warning lights when the electronic sound device button is engaged;
a means for providing a warning system for attracting the attention of automobile drivers and pedestrians and aiding in directing road and pedestrian traffic by emitting an electronic warning sound including a whistle, siren, and other warning sounds through one or more sound vents when the electronic sound device is engaged;
means for providing a regulatory information sign rigidly connected to a handle member with a electronic sound device, and when the electronic sound device is activated it allows warning sounds to pass from the electronic sound device, throughout the handle member and out through a mesh or screen sound vent or vents at the top, bottom or sides of the handle member attracting the attention of automobile drivers and pedestrians and aiding in directing road and pedestrian traffic by emitting an electronic warning sound including a whistle, siren, and other warning sounds when the electronic sound device is engaged.

2. A Handheld sign device with warning system in accordance with claim 1 comprising; a sign with handle member with an electronic warning device positioned inside the handle member. A sound device button controls the electronic sound device and the wireless battery or solar powered LED warning lights positioned on the side of the sign displaying information. The wireless battery powered LED warning lights are secured to the sign with two-sided adhesive tape enabling the lights to be removed or re-positioned without damaging the sign. Or, the lights can be permanently secured to the sign with fasteners or other fastening system. When the sound device button is pressed the electronic sound device is engaged and emits electronic warning sounds including a whistle, siren, and other warning sounds simultaneously initiating the wireless battery or solar powered LED warning lights to start flashing or to turn on and remain on continuously without flashing and with or without electronic sounds being emitted.

3. A Handheld sign device with warning system in accordance with claim 1 comprising; a sign with handle member with an electronic warning device positioned inside the handle member. The sound device button controls the electronic sound device and the wireless battery powered LED warning lights positioned on the side of the sign displaying information. When the sound device button is pressed the electronic sound device is engaged and emits electronic warning sounds including a whistle, siren, and other warning sounds simultaneously initiating the wireless battery powered LED warning lights to start flashing. The sound device button can be positioned to allow the lights to remain on continuously without flashing and without electronic sounds being emitted.

4. A Handheld sign device with warning system in accordance with claim 1, comprising; a digital sound device in the handle member that produce, manipulate, or record sound or electronic signals representing sound for providing a warning system for attracting the attention of automobile drivers and pedestrians and aiding in directing road and pedestrian traffic by emitting an electronic warning sound including a whistle, siren, and other warning sounds when the electronic sound device is engaged.

5. A Handheld sign device with warning system in accordance with claim 1, comprising; one or more mesh or screen sound vents that allows electronic warning sounds to freely escape from the handle member with clarity when the electronic sound device is activated.

6. A Handheld sign device with warning system in accordance with claim 1 comprising; a sign with handle member with an electronic warning device positioned in the handle member. And when activated emits an electronic warning sound that passes through a mesh or screen sound vent or vents at the top, bottom, or sides of the handle member.

7. A Handheld sign device with warning system in accordance with claim 1, comprising: one or more sound vents that allows electronic warning sounds to freely escape from the handle member with clarity when the electronic sound device is activated. Electronic warning sounds including whistles, sirens, amber alerts, and other electronic sounds are emitted and travels from the electronic sound device throughout the handle member and exist through a sound vent or vents at the top, bottom, or sides of the handle member attracting the attention of automobile drivers and pedestrians, and aiding in directing road and pedestrian traffic.

8. A Handheld sign device with warning system in accordance with claim 1 comprising: a sign with handle member with an electronic warning sound device positioned inside the handle member. An electronic warning device sound device button is connected to the wireless battery powered LED warning lights control board. When the sound device button is pressed it activates the electronic sound device enabling it to emit electronic sounds including a whistle or other electronic sounds while simultaneously initiating the wireless battery powered LED warning lights to start flashing or to remain on continuously without flashing and with or without electronic sounds being emitted.

9. A Handheld sign device with warning system in accordance with claim 1 comprising; a sign with one or more wireless LED warning lights secured to the sign with two-sided tape adhesive tape enabling the wireless LED lights to be removed or re-positioned anywhere on the sign by replacing the adhesive tape if necessary without damaging the sign.

10. A Handheld sign device with warning system in accordance with claim 1 comprising; a wireless LED light control board secured on or inside of the handle member and connected to the electronic sound device switch, and electronic sound device button controls the off and on function, the brightness, and the speed and duration of flashing of the wireless LED warning lights.

11. A Handheld sign device with warning system in accordance with claim 1 comprising; a sign with one or more wireless LED warning lights permanently secured with fasteners or other fastening systems.

12. A Handheld sign device with warning system in accordance with claim 1 comprising; a sign with handle member with an electronic warning device positioned inside the handle member. The electronic sound device and power switch and button are connected to the wireless remote controlled LED warning light controller giving it power from their battery or batteries. The electronic sound device button is able to activate both the electronic warning sound device and the wireless remote controlled LED warning lights. When the sound device button is pressed the electronic sound device emits electronic warning sounds including a whistle, siren, and other warning sounds simultaneously initiating the wireless LED warning lights to start flashing. The sound device button can be positioned to allow the LED warning lights to remain on constantly without flashing and without the electronic sounds device being engaged.

13. A Handheld sign device with warning system in accordance with claim 1 comprising; a sign with one or more LED warning lights directly wired to a power source, and or controls. A LED light control board secured on or inside of the handle member and connected to the electronic sound device and electronic sound device switch, controlling the electronic sound device and off and on function, the brightness, and the speed and duration of flashing of the LED warning lights.
